(19) United States
(12) Patent Application Publication
(10) Pub. No.: US 2026/0134657 A1
(43) Pub. Date: May 14, 2026

(54) LINEAR WELD SEAM RECOGNITION METHOD AND DEVICE

(71) Applicant: FAIR INNOVATION (SUZHOU) ROBOT SYSTEM CO., LTD., Suzhou (CN)

(72) Inventors: Yu SONG, Suzhou (CN); Donghui DU, Suzhou (CN); Xiaoqin ZHAI, Suzhou (CN); Yiming YAO, Suzhou (CN)

(73) Assignee: FAIR INNOVATION (SUZHOU) ROBOT SYSTEM CO., LTD., Suzhou (CN)

(21) Appl. No.: 19/389,072

(22) Filed: Nov. 14, 2025

(30) Foreign Application Priority Data
Nov. 14, 2024 (CN) 202411621006.0

(51) Int. Cl. G06V 10/44; G06T 7/13; G06T 7/64; G06V 10/77

(52) U.S. Cl. CPC G06V 10/44; G06T 7/13; G06T 7/64; G06V 10/77; G06T 2207/10028; G06T 2207/30164; G06T 2207/30244

(57) ABSTRACT

A linear weld seam recognition method and a linear weld seam recognition device are provided. The method includes: performing local photographing on a to-be-detected workpiece, and determining the number of local photographing; determining a local point cloud of the to-be-detected workpiece; determining each first structure in the local point cloud and concavity-convexity of each first structure; determining an existing structure list of the to-be-detected workpiece; merging each first structure into the existing structure list to obtain an updated structure list based on a structure merging algorithm, the number of local photographing, and the concavity-convexity of each first structure, until the number of local photographing reaches a preset number; and obtaining a latest structure list, and obtaining a first target structure and parameter information of each first target structure from the latest structure list, so as to perform the linear weld seam recognition.

### CROSS-REFERENCE TO THE RELATED APPLICATIONS

This application is based upon and claims priority to Chinese Patent Application No. 202411621006.0, filed on November 14, 2024, the entire contents of which are incorporated herein by reference.

### TECHNICAL FIELD

The present disclosure relates to the field of weld seam recognition, and particularly relates to a linear weld seam recognition method and a linear weld seam recognition device.

### BACKGROUND

The existing point cloud-based linear (straight) weld seam recognition technology requires the existence of a workpiece model point cloud to perform weld seam recognition. A general weld seam recognition process is as follows: registering a workpiece model point cloud (point cloud P, located in a workpiece model coordinate system) and an acquired workpiece point cloud (point cloud Q, located in a robot base coordinate system) to obtain a rotation matrix R and a translation vector T from the workpiece model coordinate system to the robot base coordinate system; transferring a start point and an end point of a linear weld seam selected on the workpiece model to the robot base coordinate system, and adjusting the transferred points by using a local point adjustment algorithm to obtain adjusted points. The adjusted points can be regarded as a result of weld seam recognition.

It can be seen from the above weld seam recognition process that the existing linear weld seam recognition algorithm highly depends on the existence of the workpiece model point cloud. The dependency is mainly reflected in two aspects: (1) it is necessary to register the workpiece model point cloud and the acquired workpiece point cloud to obtain a transformation relationship between two coordinate systems; (2) it is necessary to select in advance a start point and an end point of a linear weld seam on the workpiece model, and then transfer the selected start point and end point of the weld seam. If the workpiece model point cloud does not exist, the above registration and point selection operations from the model cannot be performed, and the existing weld seam recognition algorithm cannot recognize weld seams.

### SUMMARY

The objective of the present disclosure is to provide a linear weld seam recognition method and a linear weld seam recognition device, which can realize recognition of a linear weld seam when a workpiece point cloud model does not exist.

In order to achieve the above objective, the technical solution adopted in the embodiments of the present disclosure is as follows.

In a first aspect, the embodiments of the present disclosure provide a linear weld seam recognition method, and the method includes steps of:

performing local photographing on a to-be-detected workpiece, and determining the number of times of the local photographing;

determining, for each time of the local photographing, a local point cloud of the to-be-detected workpiece;

determining each first structure in the local point cloud and concavity-convexity of each first structure based on a structure search algorithm;

determining an existing structure list of the to-be-detected workpiece;

merging each first structure into the existing structure list to obtain an updated structure list based on a structure merging algorithm, the number of times of the local photographing, and the concavity-convexity of each first structure, wherein the updated structure list includes a vote count of each structure;

returning to execute the step of determining, for each time of the local photographing, a local point cloud of the to-be-detected workpiece to the step of merging each first structure into the existing structure list to obtain an updated structure list based on a structure merging algorithm and the concavity-convexity of each first structure, until the number of times of the local photographing reaches a preset number, and obtaining a latest structure list;

obtaining a first target structure with a vote count greater than the preset number and parameter information of each first target structure from the latest structure list; and

performing linear weld seam recognition based on the parameter information.

Optionally, the step of determining each first structure in the local point cloud and concavity-convexity of each first structure based on a structure search algorithm includes steps of:

detecting each plane in the local point cloud;

constructing a pair list and a triple list based on each plane, wherein the pair list includes at least one first structure formed by two planes and the concavity-convexity corresponding to this first structure, and the triple list includes at least one first structure formed by three planes and the concavity-convexity corresponding to this first structure; and

determining a pair-only list based on the pair list and the triple list.

Optionally, the step of constructing a pair list and a triple list based on each plane includes steps of:

obtaining a plane detection list based on each plane;

determining whether a plane i and a plane j have an intersection line, wherein a variable i is used to traverse each plane in the plane detection list from 0 to n, and a variable j is used to traverses each plane in the plane detection list from i+1 to n, n being the number of planes in the plane detection list;

forming a pair by the plane i and the plane j, and recording this pair in the pair list, in response to that the plane i and the plane j have an intersection line;

determining whether the plane i and a plane k have an intersection line, wherein a variable k is used to traverse each plane in the plane detection list from j+1 to n;

forming a pair by the plane i and the plane k, and recording this pair in the pair list, in response to that the plane i and the plane k have an intersection line;

determining whether the plane j and the plane k have an intersection line;

forming a pair by the plane j and the plane k, and recording this pair in the pair list, in response to that the plane j and the plane k have an intersection line;

determining whether the plane i and the plane j have an intersection line, whether the plane i and the plane k have an intersection line, and whether the plane j and the plane k have an intersection line;

forming a triple list by the plane i, the plane j, and the plane k, and recording this triple list in the triple list, in response to that the plane i and the plane j have an intersection line, the plane i and the plane k have an intersection line, and the plane j and the plane k have an intersection line;

determining coordinates of a camera optical center during the local photographing; and

determining the concavity-convexity of each first structure in the pair list and the concavity-convexity of each first structure in the triple list based on the coordinates of the camera optical center.

Optionally, the step of determining a pair-only list based on the pair list and the triple list includes steps of:

determining whether a triple j includes a pair i, wherein a variable i is used to traverse the pair list, and a variable j is used to traverse the triple list; and

in response to that the triple j does not include the pair i, determining the pair i as a pair-only, and adding the pair-only to a pair-only list.

Optionally, the step of merging each first structure into the existing structure list to obtain an updated structure list based on a structure merging algorithm, the number of times of the local photographing, and the concavity-convexity of each first structure includes:

in response to that the number of times of the local photographing is zero, adding each first structure to the existing structure list to obtain the updated structure list, and assigning the vote count of a newly added first structure in the updated structure list to 1.

Optionally, the step of merging each first structure into the existing structure list to obtain an updated structure list based on a structure merging algorithm, the number of times of the local photographing, and the concavity-convexity of each first structure, and updating the vote count of each structure in the updated structure list includes steps of:

in response to that the number of times of the local photographing is not zero, determining a new triple list according to the triple list and a target triple list in the existing structure list, wherein the existing structure list includes the target triple list;

updating the existing structure list based on the triple list and the target triple list;

updating the existing structure list based on the new triple list and a target pair-only list in the existing structure list, wherein the existing structure list includes the target pair-only list;

obtaining a temporary pair-only list based on the pair-only list and the target triple list;

updating the existing structure list based on the pair-only list and the target triple list; and

updating the existing structure list based on the temporary pair-only list and the target pair-only list.

Optionally, the step of updating the existing structure list based on the triple list and the target triple list includes:

determining whether a triple a and a target triple b have three common dihedral structures with identical concavity-convexity, wherein a variable a is used to traverse the triple list, and a variable b is used to traverse the target triple list;

in response to that the triple a and the target triple b have three common dihedral structures with identical concavity-convexity, merging the triple a into the existing structure list to obtain an updated structure list, and updating a vote count of the target triple b in the updated structure list;

in response to that the triple a and the target triple b do not have three common dihedral structures with identical concavity-convexity, determining whether the triple a and the target triple b have one common dihedral structure with identical concavity-convexity;

in the case that the triple a and the target triple b have one common dihedral structure with identical concavity-convexity, determining an associated structure list corresponding to the target triple b;

determining whether the associated structure list includes a second target structure having three common dihedral structures with the triple a wherein these dihedral structures have identical concavity-convexity;

in response to that the associated structure list includes the second target structure having three common dihedral structures with the triple a wherein these dihedral structures have identical concavity-convexity, determining a target label of the second target structure in the existing triple list, and

merging the triple a into the existing structure list to obtain the updated structure list;

in response to that the associated structure list does not include the second target structure having three common dihedral structures with the triple a wherein these dihedral structures have identical concavity-convexity, adding the triple a to the existing structure list to obtain the updated structure list; and

in response to that the triple a and the target triple b have no common dihedral structure, adding the triple a to the existing structure list to obtain the updated structure list.

Optionally, the step of updating the existing structure list based on the new triple list and a target pair-only list in the existing structure list includes:

determining whether a new triple i and a target pair-only j have a common dihedral structure with identical concavity-convexity, wherein a variable i is used to traverse each new triple in a new triple list, and a variable j is used to traverse each target pair-only list in a target pair-only list; and

in response to that the new triple i and the target pair-only j have a common dihedral structure with identical concavity-convexity, updating an intersection line of the new triple i based on an intersection line of the target pair-only j.

Optionally, the step of obtaining a temporary pair-only list based on the pair-only list and the target triple list includes:

determining whether a pair-only i and a target triple j have a common dihedral structure with identical concavity-convexity, wherein the variable i is used to traverse each pair-only in the pair-only list, and the variable j is used to traverse each target triple in the target triple list;

in response to that the pair-only i and the target triple j have a common dihedral structure with identical concavity-convexity, updating an intersection line of the target triple j based on an intersection line of the pair-only i; and

in response to that the pair-only i and the target triple j have no common dihedral structure, adding the pair-only i to the temporary pair-only list.

In a second aspect, the embodiments of the present disclosure provide a linear weld seam recognition device, including: a determination module, configured for performing local photographing on a to-be-detected workpiece, and determining the number of times of the local photographing; determining, for each time of the local photographing, a local point cloud of the to-be-detected workpiece; determining each first structure in the local point cloud and concavity-convexity of each first structure based on a structure search algorithm; determining an existing structure list of the to-be-detected workpiece;

an updating module, configured for merging each first structure into the existing structure list to obtain an updated structure list based on a structure merging algorithm, the number of local photographing, and the concavity-convexity of each first structure, wherein the updated structure list includes a vote count of each structure;

a returning execution module, configured for returning to execute the step of determining, for each time of the local photographing, a local point cloud of the to-be-detected workpiece to the step of merging each first structure into the existing structure list to obtain an updated structure list based on a structure merging algorithm and the concavity-convexity of each first structure, until the number of times of the local photographing reaches a preset number, and obtaining a latest structure list;

an obtaining module, configured for obtaining a first target structure with a vote count greater than the preset number and parameter information of each first target structure from the latest structure list; and

a recognizing module, configured for performing linear weld seam recognition based on the parameter information.

In a third aspect, embodiments of the present disclosure provide an electronic device including a memory and a processor, wherein the memory stores a computer program, and the processor executes the computer program to implement steps of the linear weld seam recognition method.

In a fourth aspect, the present disclosure further provides a computer-readable storage medium, on which a computer program is stored, and when the computer program is executed by a processor, steps of the linear weld seam recognition method are implemented.

The present disclosure has the following beneficial effects.

The present disclosure adopts the steps of performing local photographing on a to-be-detected workpiece, and determining the number of local photographing; determining, for each local photographing, a local point cloud of the to-be-detected workpiece; determining each first structure in the local point cloud and concavity-convexity of each first structure based on a structure search algorithm; determining an existing structure list of the to-be-detected workpiece; merging each first structure into the existing structure list to obtain an updated structure list based on a structure merging algorithm, the number of local photographing, and the concavity-convexity of each first structure, wherein the updated structure list includes a vote count of each structure; returning from executing the step determining, for each local photographing, a local point cloud of the to-be-detected workpiece to the step of merging each first structure into the existing structure list to obtain an updated structure list based on a structure merging algorithm and the concavity-convexity of each first structure, until the number of the local photographing reaches a preset number to obtain a latest structure list; obtaining a first target structure with a vote count greater than a preset number and parameter information of each first target structure from the latest structure list; and performing linear weld seam recognition based on each parameter information. Therefore, in a process of successively photographing a to-be-detected workpiece, a linear weld seam is constructed by performing structure detection and voting, and a linear weld seam recognition result is obtained from a construction result, thereby realizing recognition of the linear weld seam when a workpiece point cloud model does not exist.

### BRIEF DESCRIPTION OF THE DRAWINGS

To more clearly illustrate the technical solutions of the embodiments of the present disclosure, the following will briefly introduce the drawings used in the embodiments. It should be understood that the following drawings only show some embodiments of the present disclosure, and therefore they should not be regarded as a limitation on the scope. Those ordinary skilled in art can also obtain other related drawings based on these drawings without inventive effort.

FIG. 1 is a block schematic diagram of an electronic device provided in an embodiment of the present disclosure;

FIG. 2 is a flowchart of a linear weld seam recognition method provided in an embodiment of the present disclosure;

FIG. 3 is another flowchart of a linear weld seam recognition method provided in an embodiment of the present disclosure;

FIG. 4 is a schematic diagram of plane division provided in an embodiment of the present disclosure;

FIG. 5 is another flowchart of a linear weld seam recognition method provided in an embodiment of the present disclosure;

FIG. 6 is a schematic diagram of two trihedral structures sharing one intersection line provided in an embodiment of the present disclosure;

FIG. 7 is another flowchart of a linear weld seam recognition method provided in an embodiment of the present disclosure;

FIG. 8 is another flowchart of a linear weld seam recognition method provided in an embodiment of the present disclosure; and

FIG. 9 is a flowchart of a linear weld seam recognition device provided in an embodiment of the present disclosure.

### DETAILED DESCRIPTION OF THE EMBODIMENTS

In order to make the objective, technical solution, and advantages of the present disclosure clearer, the following will provide a clear and complete description of the technical solution in the embodiments of the present disclosure, in conjunction with the drawings in the embodiments of the present disclosure. Obviously, the described embodiments are a part of the embodiments of the present disclosure, rather than all embodiments. The components of embodiments of the present disclosure which are generally described and illustrated in the drawings herein can be arranged and designed in a variety of different configurations.

Accordingly, the following detailed description of the embodiments of the present disclosure provided in the drawings is not intended to limit the scope of the claimed disclosure, but merely represents selected embodiments of the present disclosure. Based on the embodiments of the present disclosure, all other embodiments obtained by those of ordinary skill in the art without making inventive efforts are within the scope of protection of the present disclosure.

It should be noted that similar numerals and letters denote similar terms in the following drawings so that once an item is defined in one drawing, it does not need to be further discussed in subsequent drawings.

In the description of the present disclosure, it should be noted that the orientation or position relationships indicated by the terms 'up’, 'down’, 'inside’, 'outside’, etc. are the orientation or position relationships shown based on the drawings or the orientation or position relationships customarily placed in the use of the product of the present disclosure. It is only for the convenience of describing the present disclosure and simplifying its description, and does not indicate or imply that the device or element referred to must be in a specific orientation or be constructed and operated in a specific orientation, and thus should not be construed as limiting the present disclosure.

In addition, the terms such as “first”, “second”, are only used to distinguish the descriptive and are not to be construed as indicating or implying relative importance.

In the description of the present disclosure, it is further important to note that unless otherwise clearly stipulated and limited, the terms “provide”, “mount”, “interconnect”, and “connect” should be understood in a broad sense, for example, it can be a fixed connection, a detachable connection, or an integral connection; it can be a mechanical connection, or an electrical connection; and it can be a direct connection, an indirect connection through an intermediary, or an internal communication between two components. Those of ordinary skill in the art can understand the meanings of the above terms in the present disclosure according to specific situations.

After extensive research by the inventors, it is found that when a workpiece model point cloud does not exist, recognition of a linear weld seam cannot be performed.

In view of the above discovery, the present embodiment provides a linear weld seam recognition method and a linear weld seam recognition method device. The method includes: performing local photographing on a to-be-detected workpiece, and determining the number of times of the local photographing; determining, for each time of the local photographing, a local point cloud of the to-be-detected workpiece; determining each first structure in the local point cloud and concavity-convexity of each first structure based on a structure search algorithm; determining an existing structure list of the to-be-detected workpiece; merging each first structure into the existing structure list to obtain an updated structure list based on a structure merging algorithm, the number of times of the local photographing, and the concavity-convexity of each first structure, wherein the updated structure list includes a vote count of each structure; returning to execute the step of determining, for each time of the local photographing, a local point cloud of the to-be-detected workpiece to the step of merging each first structure into the existing structure list to obtain an updated structure list based on a structure merging algorithm and the concavity-convexity of each first structure, until the number of times of the local photographing reaches a preset number, and obtaining a latest structure list; obtaining a first target structure with a vote count greater than the preset number and parameter information of each first target structure from the latest structure list; and performing linear weld seam recognition based on the parameter information. Therefore, in a process of successively photographing a to-be-detected workpiece, a linear weld seam is constructed by performing structure detection and voting, and a linear weld seam recognition result is obtained from a construction result, thereby realizing recognition of the linear weld seam when a workpiece point cloud model does not exist. The following provides a detailed description of the solution provided by the present embodiment.

The present embodiment provides an electronic device capable of recognizing a linear weld seam. In one possible implementation, the electronic device can be a user terminal. For example, the electronic device can be, but is not limited to, a server, a smartphone, a personal computer (PC), a tablet computer, a personal digital assistant (PDA), a mobile internet device (MID), and a weld seam recognition robot.

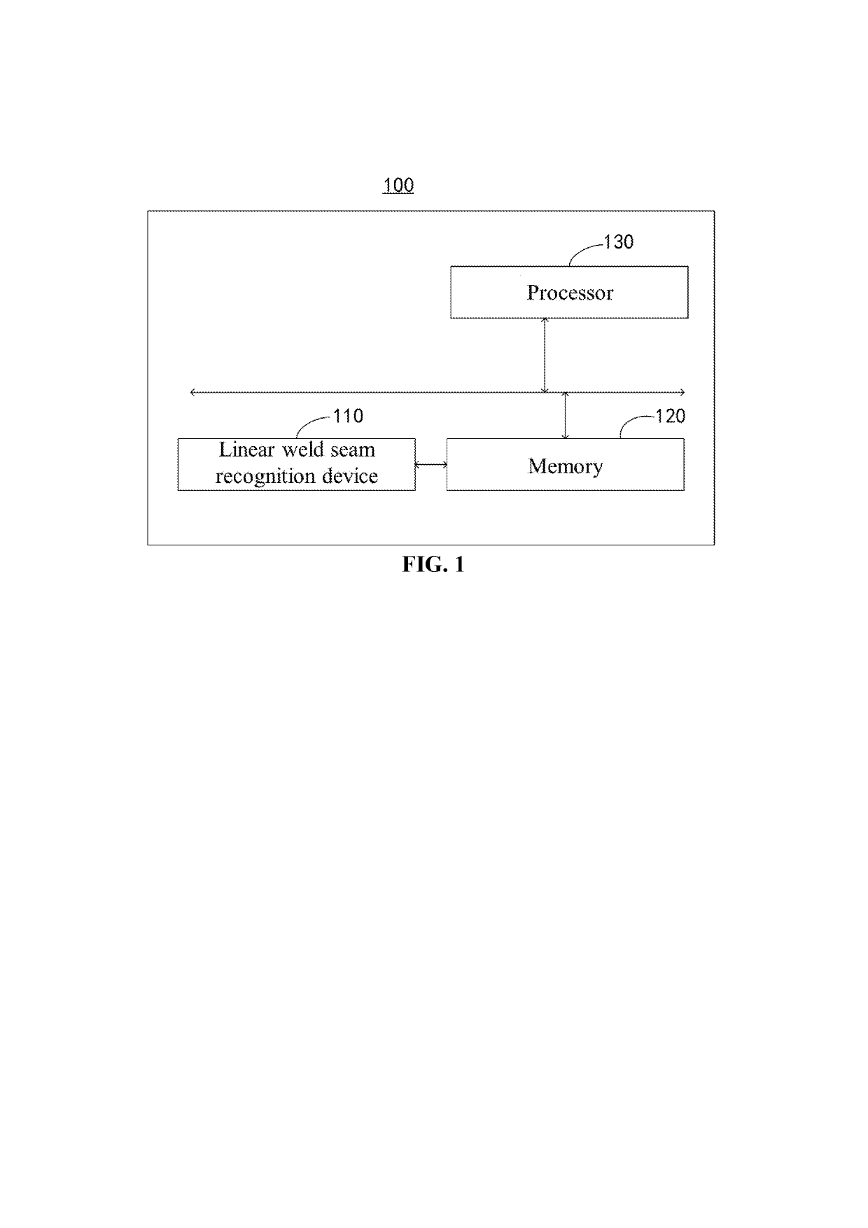

Referring to FIG. 1, FIG. 1 is a schematic diagram of the structure of an electronic device 100 provided by the embodiment of the present disclosure. The electronic device 100 can include more or fewer components than those shown in FIG. 1 or can be configured differently from what is depicted in FIG. 1. The components shown in FIG. 1 can be implemented using hardware, software, or a combination thereof.

The electronic device 100 includes a linear weld seam recognition device 110, a memory 120, and a processor 130.

The memory 120 and the processor 130 are electrically connected to each other directly or indirectly to enable data transmission or interaction. For example, these components can be electrically connected to each other through one or more communication buses or signal lines. The linear weld seam recognition device 110 includes at least one software functional module stored in the form of software or firmware in the memory 120 or embedded in the operating system (OS) of the electronic device 100. The processor 130 is configured to execute the executable modules stored in the memory 120, such as the software functional module or computer program included in the linear weld seam recognition device 110.

The memory can be, but is not limited to, random access memory (RAM), read-only memory (ROM), programmable read-only memory (PROM), erasable programmable read-only memory (EPROM), electrically erasable programmable read-only memory (EEPROM), and the like. The memory 120 is configured for storing the program. Upon receiving an execution instruction, the processor 130 execute the program.

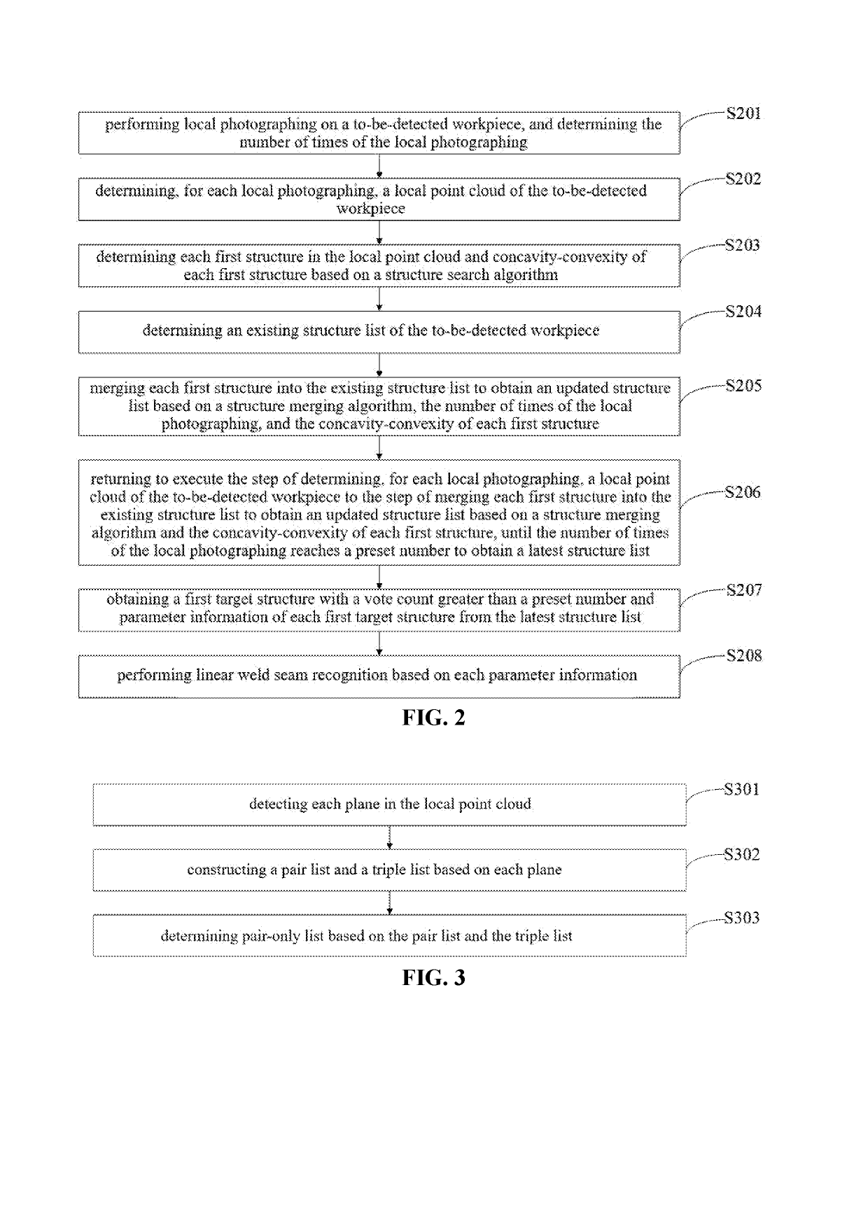

Referring to FIG. 2, FIG. 2 is a flowchart of a linear weld seam recognition method applied to the electronic device 100 of FIG. 1. The following provides a detailed description of the method including the steps of S201- S208:

S201, performing local photographing on a to-be-detected workpiece, and determining the number of times of the local photographing;

S202, determining, for each local photographing, a local point cloud of the to-be-detected workpiece;

S203, determining each first structure in the local point cloud and concavity-convexity of each first structure based on a structure search algorithm;

S204, determining an existing structure list of the to-be-detected workpiece;

S205, merging each first structure into the existing structure list to obtain an updated structure list based on a structure merging algorithm, the number of times of the local photographing, and the concavity-convexity of each first structure,

wherein the updated structure list includes a vote count of each structure;

S206, returning to execute the step of determining, for each time of the local photographing, a local point cloud of the to-be-detected workpiece to the step of merging each first structure into the existing structure list to obtain an updated structure list based on a structure merging algorithm and the concavity-convexity of each first structure, until the number of times of the local photographing reaches a preset number, and obtaining a latest structure list;

S207, obtaining a first target structure with a vote count greater than the preset number and parameter information of each first target structure from the latest structure list; and

S208, performing linear weld seam recognition based on the parameter information.

The local photographing is performed on a to-be-detected workpiece, and the number of times of the local photographing is recorded. The number of times of local photographing can be set to 0 to indicate performing a first time of the photographing on the to-be-detected workpiece, and set to 1 to indicate performing a second time of the photographing on the to-be-detected workpiece. The camera poses for the number of times of the local photographing being 0 and the camera poses for the number of times of the local photographing being 1 are different.

When the number of times of the local photographing does not meet a preset photographing number of times, the camera pose is adjusted to perform the next local photographing. Since no information of any workpiece model exists at present, no pose information of any workpiece point cloud exists either, and therefore the photographing here is somewhat tentative. During workpiece welding, a placement range of the to-be-detected workpiece can be delineated on the ground, and the to-be-detected workpiece is placed within the placement range. During photographing, the robot acquires the local point cloud of the to-be-detected workpiece within the placement range; that is, each time the to-be-detected workpiece is locally photographed, the local point cloud of the to-be-detected workpiece is acquired.

A structure search algorithm is used to determine a first structure of the local point cloud of the to-be-detected workpiece collected in each local photographing. The first structure includes a trihedral structure and an dihedral-only structure. The concavity-convexity can be assigned to each first structure based on the camera optical center coordinates when acquiring the local point cloud.

Each first structure is merged into the existing structure list to obtain an updated structure list based on a structure merging algorithm, the number of times of the local photographing, and the concavity-convexity of each first structure, wherein the updated structure list includes a vote count of each structure.

The existing structure list can be obtained by, when the number of times of the local photographing indicates the first photographing, directly storing the first structures detected in the local point cloud into a structure record to obtain the existing structure list, and assigning a vote count of 1 to each first structure in the existing structure list.

When the number of times of the local photographing does not indicate the first photographing, the first structures detected in the local point cloud are merged into the existing structure list, and the vote count of each structure in the existing structure list is updated to obtain an updated structure list.

The local point cloud corresponding to the first local photographing is determined, and each first structure in the local point cloud and the concavity-convexity of each first structure based on the structure search algorithm are determined, and the existing structure list of the to-be-detected workpiece is determined. Based on a structure merging algorithm, the number of times of the local photographing, and the concavity-convexity of each first structure, each first structure is merged into the existing structure list to obtain an updated structure list, i.e., the first structure list, wherein the first structure list includes a vote count of each structure.

The local point cloud corresponding to the second local photographing is determined, and each first structure in the local point cloud and the concavity-convexity of each first structure based on the structure search algorithm are determined, and the existing structure list of the to-be-detected workpiece is determined. Based on a structure merging algorithm, the number of times of the local photographing, and the concavity-convexity of each first structure, each first structure is merged into the existing structure list to obtain an updated structure list, i.e., the second structure list, wherein the second structure list includes a vote count of each structure. The process continues until the number of times of the local photographing reaches a preset number, and then, the latest structure list is obtained. The first target structures with a vote count greater than a preset number, along with the parameter information of each first target structure, are acquired from the latest structure list. The linear weld seam recognition is performed based on the parameter information.

When the number of times of the local photographing reaches the preset number, it indicates that photographing is completed, and at this time, all first structures on the to-be-detected workpiece and the vote count of each first structure have been obtained. Each structure in the latest structure list is traversed. A vote count of a first target structure greater than the preset number indicates the existence of the first target structure on the real workpiece. At the same time, the parameter information of the first target structure is provided, including a start point and an end point of the linear weld seam in the first target structure, thereby completing the linear weld seam recognition.

There are various implementations for determining each first structure in the local point cloud and the concavity-convexity of each first structure based on the structure search algorithm. In one implementation, as shown in FIG. 3, it includes the following steps:

S301, detecting each plane in the local point cloud;

S302, constructing a pair (2-tuple) list and a triple (3-tuple) list based on each plane,

wherein the pair list includes at least one first structure formed by two planes and the concavity-convexity corresponding to the first structure, and the triple list includes at least one first structure formed by three planes and the concavity-convexity corresponding to the first structure; and

S303, determining a pair-only list based on the pair list and the triple list.

Based on each plane, the pair list and the triple list can be constructed by the following steps:

obtaining a plane detection list based on each plane; determining whether a plane i and a plane j have an intersection line, wherein variable i traverses each plane in the plane detection list from 0 to n, and variable j traverses each plane in the plane detection list from i+1 to n, n being the number of planes in the plane detection list; forming a pair by the plane i and the plane j, and recording the pair in the pair list, in response to that the plane i and the plane j have an intersection line; determining whether the plane i and a plane k have an intersection line, wherein variable k traverses each plane in the plane detection list from j+1 to n; forming a pair by the plane i and the plane k, and recording the pair in the pair list, in response to that the plane i and the plane k have an intersection line; determining whether the plane j and the plane k have an intersection line; forming a pair by the plane j and the plane k, and recording the pair in the pair list, in response to that the plane j and the plane k have an intersection line; determining whether the plane i and the plane j have an intersection line, whether the plane i and the plane k have an intersection line, and whether the plane j and the plane k have an intersection line; forming a triple list by the plane i, the plane j, and the plane k, and recording the triple list in the triple list, in response to that the plane i and the plane j have an intersection line, the plane i and the plane k have an intersection line, and the plane j and the plane k have an intersection line; determining coordinates of a camera optical center during the local photographing; and determining the concavity-convexity of each first structure in the pair list and the concavity-convexity of each first structure in the triple list based on the coordinates of the camera optical center.

There are various implementations for determining the concavity-convexity of each first structure in the pair list and the concavity-convexity of each first structure in the triple list based on the coordinates of the camera optical center. In one implementation,

the concavity-convexity of each first structure in the pair list is determined based on the coordinates of the camera optical center. As shown in FIG. 4, a schematic diagram of coordinates of the camera optical center and the relationship with a first structure being a dihedral structure is shown, wherein the dihedral structure includes plane 1 and plane 2. When judging the concavity-convexity of the first structure, firstly, the plane 1 is used to split the plane 2. The relative position of the coordinates of the camera optical center with respect to plane 1 is determined; that is, whether the coordinates of the camera optical center are on the left side or right side of plane 1. As shown in FIG. 4, the coordinates of the camera optical center are on the right side of plane 1. At this time, the portion of plane 2 located on the right side of plane 1 is retained. Then, the plane 2 is used to split the plane 1 and the relative position of the coordinates of the camera optical center with respect to plane 2 is determined; that is, whether the coordinates of the camera optical center are on the upper side or lower side of plane 2. As shown in FIG. 4, the coordinates of the camera optical center are on the upper side of plane 2, and at this time, the portion of plane 1 located on the upper side of plane 2 is retained. After splitting the two planes, it is possible to determine whether the intersection line, formed by the plane 1 and the plane 2 in the first structure, is convex or concave, thereby determining the concavity-convexity of the first structure.

Based on the coordinates of the camera optical center, the concavity-convexity of each first structure in the triple list is determined. For example, if the triple list includes any triple corresponding to a first structure, such as (i, j, k), indicating that the first structure is formed by plane i, plane j, and plane k, then the concavity-convexity of the intersection line formed by plane i and plane j is determined, the concavity-convexity of the intersection line formed by plane j and plane k is determined, and the concavity-convexity of the intersection line formed by plane i and plane k is determined. Therefore, the concavity-convexity corresponding to the triple (i, j, k) is finally obtained. The manner of determining the concavity-convexity of the intersection line formed by plane i and plane j, the intersection line formed by plane j and plane k, and the intersection line formed by plane i and plane k is consistent with the manner of determining the concavity-convexity of the intersection line formed by plane 1 and plane 2, and will not be repeated herein.

There are various implementations for determining the pair-only list based on the pair list and the triple list. For example,

a variable i is used to traverse each pair in the pair list, and a variable j is used to traverse each triple list in the triple list. For the i-th pair, whether it is included in the j-th triple is determined. The j-th triple is represented as (u, v, w). If (u, v), (u, w), or (v, w) matches the labels in the pair, the triple contains the pair. If it is determined that the j-th triple contains the i-th pair, a flag corresponding to the current pair is set to 1. The flag of 1 indicates that the current pair is not a pair-only (only pair), and a flag of 0 indicates that the current pair is a pair-only. The meaning of a pair-only is that the pair does not appear in any triple. After traversal of i and j as described above, it is possible to determine whether a pair is a pair-only. Variable i is used to traverse each pair in the pair list. When a flag of an i-th pair is determined to be 0, the two planes of the i-th pair are split based on the coordinates of the camera optical center to determine concavity or convexity of the pair, and the i-th pair is stored into a pair-only list.

Based on the structure search algorithm, all trihedral structures and their concavity-convexity in the current local point cloud can be obtained. A trihedral structure is a structure in which three planes mutually have intersection lines between each other. The trihedral structures and their concavity-convexity are stored in the triple list. At the same time, all dihedral-only structures and their concavity-convexity in the current local point cloud are also obtained. A dihedral-only structure is a structure in which two planes have an intersection line, but this dihedral structure does not belong to any trihedral structure. The dihedral-only structures and their concavity-convexity are stored in the pair-only list.

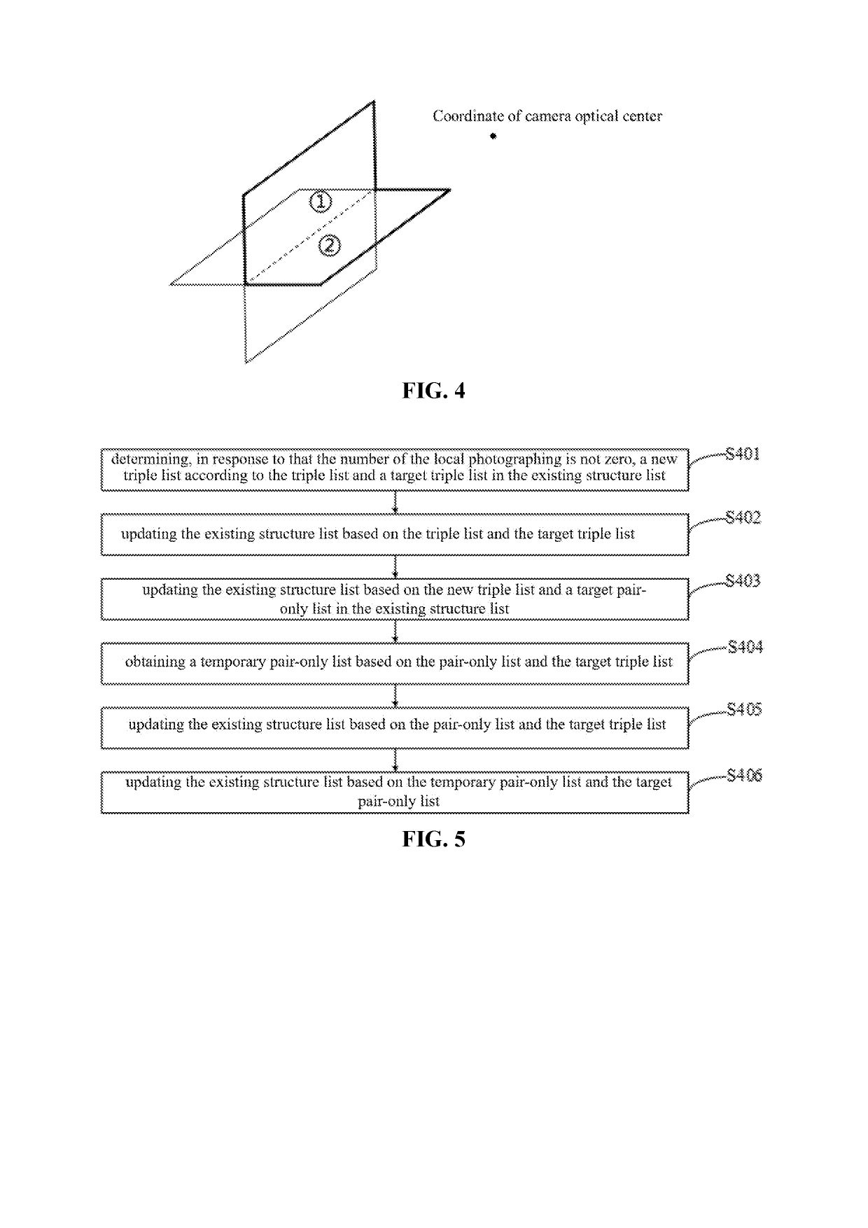

There are various implementations for merging each first structure into the existing structure list to obtain an updated structure list based on a structure merging algorithm, the number of times of the local photographing, and the concavity-convexity of each first structure. In one implementation, as shown in FIG. 5, it includes the following steps:

S401, determining, in response to that the number of times of the local photographing is not zero, a new triple list according to the triple list and a target triple list in the existing structure list,

wherein the existing structure list includes the target triple list;

S402, updating the existing structure list based on the triple list and the target triple list;

S403, updating the existing structure list based on the new triple list and a target pair-only list in the existing structure list,

wherein the existing structure list includes the target pair-only list;

S404, obtaining a temporary pair-only list based on the pair-only list and the target triple list;

S405, updating the existing structure list based on the pair-only list and the target triple list; and

S406, updating the existing structure list based on the temporary pair-only list and the target pair-only list.

The manner of updating the existing structure list based on the triple list and the target triple list and determining the new triple list includes:

determining whether a triple a and a target triple b have three common dihedral structures and the concavity-convexity of the dihedral structures are identical, wherein a variable a traverses the triple list and a variable b traverses the target triple list; in response to determining that triple a and target triple b have three common dihedral structures and that the concavity-convexity of the dihedral structures are identical, merging the triple a into the existing structure list to obtain an updated structure list, and updating a vote count of the target triple b in the updated structure list; in response to determining that triple a and the target triple b do not have three common dihedral structures with identical concavity-convexity, determining whether the triple a and the target triple b have one common dihedral structure and the concavity-convexity of the dihedral structure are identical; in response to determining that the triple a and the target triple b have one common dihedral structure and that the concavity-convexity of the dihedral structure are identical, determining an associated structure list corresponding to the triple b; determining whether the associated structure list includes a second target structure having three common dihedral structures with the triple list a and whether the concavity-convexity of the dihedral structures are identical; in response to the associated structure list including the second target structure having three common dihedral structures with the triple a and the concavity-convexity of the dihedral structures being identical, determining a target label of the second target structure in the existing triple list, and merging the triple a into the existing structure list to obtain the updated structure list; in response to the associated structure list not including the second target structure having three common dihedral structures with the triple list a or the concavity-convexity of the dihedral structures not being identical, adding the triple a to the existing structure list to obtain the updated structure list; and in response to determining that the triple a and the target triple b have no common dihedral structure, adding the triple a to the existing structure list to obtain the updated structure list.

A variable a is used to traverse each triple in the triple list of the current local point cloud, and a variable b is used to traverse each target triple in the target triple list of the existing structure list. It is determined whether the triple a and the target triple b have three common dihedral structures, and whether the concavity-convexity of these dihedral structures are all the same. If so, it indicates that the triple a and the target triple b represent the same trihedral structure in the to-be-detected workpiece. At this time, the existing structure list is updated by merging the triple a into the existing structure list. Since the current local point cloud is obtained by the camera at a new shooting pose, and that the same trihedral structure as an existing one is detected in the current local point cloud, the confidence level of the trihedral structure representing a real trihedral structure is increased. In the existing structure list, each trihedral structure is provided with a voting number, and the voting number characterizes the confidence level of the trihedral structure. The vote count of the target triple list b is increased by one.

When the triple list a and the target triple list b have three common dihedral structures and the concavity-convexity of the dihedral structures are all the same, the triple a is merged into the existing structure list to obtain an updated structure list. The specific manner of merging can include the following.

When the triple a and the target triple b have three common dihedral structures and the concavity-convexity of the dihedral structures are all the same, the first intersection lines of the triple a and the second intersection lines of the target triple b are determined, wherein each first intersection line corresponds to a second intersection line. The first start point and the first end point of the first intersection line, and the second start point and the second end point of the second intersection line are determined. For each first intersection line, a union of the first start point and the first end point of the first intersection line, and the second start point and the second end point of the second intersection line corresponding to the first intersection line is determined, and the corresponding intersection line in the target triple b is updated by the union to obtain an updated structure list.

It should be noted that when the triple a and the target triple b have three common dihedral structures and the concavity-convexity of the dihedral structures are all the same, the triple a and the target triple b represent the same trihedral structure, but the ranges of the planes captured by the camera may be different. Therefore, it is necessary to update the intersection lines of the trihedral structure in the target triple b. The updating manner is to sequentially update each intersection line. Specifically, by setting the triple a to be represented as (i1, i2, i3), and the target triple b to be represented as (j1, j2, j3), the start point and end point of the intersection line (i1, i2) and the start point and end point of the intersection line (j1, j2) are obtained. The union of the start point and end point of the intersection line (i1, i2) and the start point and end point of the intersection line (j1, j2) is used to update the start point and end point of the intersection line (j1, j2) in the target triple b. The remaining two intersection lines are updated in the same manner.

When the triple a and the target triple b do not have three common dihedral structures or the concavity-convexity of the dihedral structures are not the same, it is determined whether the triple a and the target triple b have one common dihedral structure and whether the concavity-convexity of the dihedral structure are the same. If so, two cases are further distinguished as follows.

The first case is as follows: traversing the associated structure list of the target triple b. When a second target structure, which has three common dihedral structures with the triple a and the concave–convex property of the dihedral structures are the same, exists in the associated structure list of target triple b, it indicates that the triple a already exists in the existing structure list. The target label of the triple corresponding to triple a, in the associated structure list corresponding to the target triple b, is set as i_index, and the target label is the label of the triple corresponding to triple a in the existing structure list, in the associated structure list. At this time, the existing structure list is updated, and the triple a is merged into the existing structure list. The voting number of the triple of i_index in the existing structure list is increased by 1, and the three intersection lines of the trihedral structure of the triple of i_index are updated.

The second case is as follows: traversing the associated structure list of target triple b. When there is no structure, which has three common dihedral structures with the triple a and the concave–convex property of the dihedral structures are the same, exists in the associated structure list, it indicates that triple a is a new trihedral structure but shares one intersection line with the existing trihedral structure. The situation in which two trihedral structures share one intersection line is shown in FIG. 6. In FIG. 6, a three-concave structure and an adjacent two- concave-one-convex structure are shown, and the two trihedral structures share one intersection line.

When there is no second target structure in the associated structure list that shares three common dihedral structures with triple a or the concave–convex of the dihedral structures are different, the triple a is added to the existing structure list for updating: the triple a is added to the existing structure list, the vote count is set to 1, the vote count of the target triple b is increased by 1, the intersection lines of the shared dihedral structures in the target triple b are updated, and the newly added triple list label is recorded in the new triple list.

After traversal of the target triple list is completed, when there is no shared dihedral structure between the triple a and the target triple b, the existing structure list is updated. If traversal of b has been completely and the target triple b and the triple a share no dihedral structure, it indicates that the target triple b does not share any dihedral structure with any trihedral structure in the existing structure list. In this case, the triple a is added to the existing structure list, and the vote count of the triple a is set to 1.

Before determining the associated structure list corresponding to the target triple b, the associated structure list corresponding to the existing structure list can be obtained based on the existing structure list. The specific process is as follows:

using a variable d to traverse all triples in the existing structure list, wherein d starts from 0; and using variable e to traverse all triples in the existing structure list, where e starts from d + 1. The triple d and the triple e are extracted, and whether the triple d and the triple e share a common dihedral structure is determined. If yes, it indicates that the triple d and the triple e are mutually associated. The triple e is added to the associated structure list of triple d, and the associated line label is added at the same time; the triple d is added to the associated structure list of the triple e, and the associated line label is also added. The associated structure list can be represented by a vector, each element of which contains three values: a first value representing the label of the triple associated with the current triple, a second value representing the first label of the associated line in the current triple, and a third value representing the second label of the associated line in the associated triple.

There are various implementations for updating the existing structure list based on the new triple list and a target pair-only list in the existing structure list. In one implementation, as shown in FIG. 7, it includes the following steps:

S501, determining whether a new triple i and a target pair-only j have a common dihedral structure and whether the concavity-convexity of the dihedral structure are identical,

wherein the variable i is used to traverse each new triple in a new triple, and the variable j is used to traverse target pair-only in the target pair-only list; and

S502, in response to the new triple i and the target pair-only j having a common dihedral structure and the concavity-convexity of the dihedral structure being identical, updating an intersection line of the new triple i based on an intersection line of the target pair-only j,

wherein the variable i traverses each new triple in a new triple list, and the variable j traverses each target pair-only list in a target pair-only list; and extracting the new triple i from the new triple list, and determining whether a new triple i and a target pair-only j have a common dihedral structure and whether the concavity-convexity of the dihedral structure are identical, if yes, updating an existing structure list; the step of updating an intersection line of the new triple i in the existing structure list includes: deleting the target pair-only j in a target pair-only list from the existing structure list; and increasing a vote count of the new triple i in the existing structure list by 1.

Since any plane has a certain thickness, there is no truly dihedral-only structure in the to-be-detected workpiece. Any dihedral-only structure should belong to a certain trihedral structure.

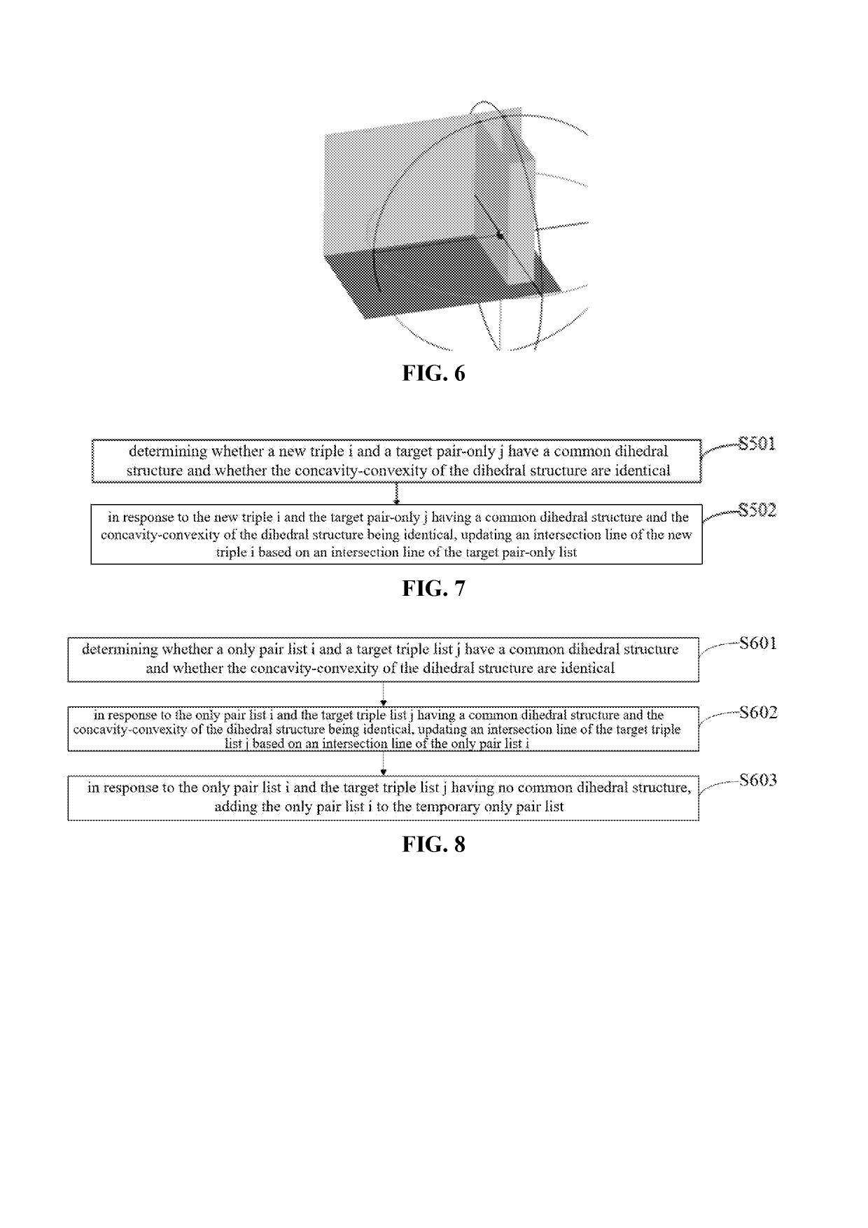

There are various implementations for obtaining a temporary pair-only list based on the pair-only list and the target triple list. In one implementation, as shown in FIG. 8, it includes the following steps:

S601, determining whether a pair-only list i and a target triple j have a common dihedral structure and whether the concavity-convexity of the dihedral structure are identical,

wherein the variable i is used to traverse each pair-only in the pair-only list, and the variable j is used to traverse each target triple in the target triple list;

S602, in response to the pair-only i and the target triple j having a common dihedral structure and the concavity-convexity of the dihedral structure being identical, updating an intersection line of the target triple j based on an intersection line of the pair-only i; and

S603, in response to the pair-only i and the target triple j having no common dihedral structure, adding the pair-only i to the temporary pair-only list.

The variable i is used to traverse each pair-only in the pair-only list, and the variable j is used to traverse each target triple in the existing structure list. It is determined whether the pair-only i and the target triple j share a common dihedral structure and whether the concave–convex property of the dihedral structure is the same. If yes, the existing structure list is updated by increasing the vote count of the target triple j by 1, and the process directly proceeds to the step of adding i. If the traversal of j is completed, indicating that the pair-only i does not overlap with any triple in the existing structure list, and the pair-only i is stored into a temporary list.

The implementation of updating the existing structure list based on the temporary pair-only list and the target pair-only list can be achieved by:

using the variable i to traverse each temporary pair-only in the temporary pair-only list; using the variable j to traverse each target pair-only in the target pair-only list in the existing structure list; determining whether the temporary pair-only i and the target pair-only j share a common dihedral structure and whether the concave–convex property of the dihedral structure is the same; when the temporary pair-only i and the target pair-only j share a common dihedral structure and the concave–convex property is the same, proceeding directly to the step of increasing i; upon completion of the traversal of j, indicating that the temporary pair-only i is a new pair-only, adding the temporary pair-only i to the existing structure list and updating the existing structure list.

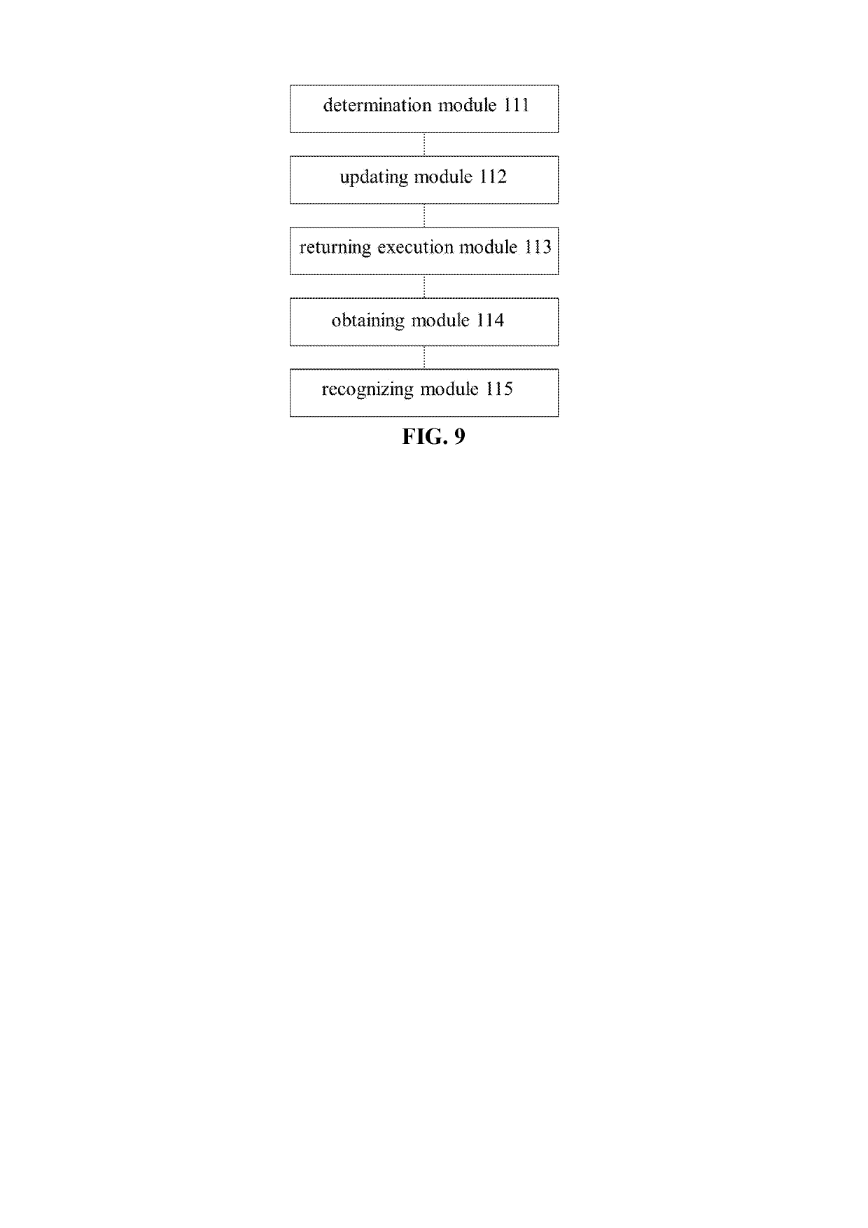

Referring to FIG. 9, a linear weld seam recognition device 110 applied to the electronic device 100 shown in FIG. 1 is further provided in the present disclosure. The linear weld seam recognition device 110 includes:

a determination module 111, configured for performing local photographing on a to-be-detected workpiece, and determining the number of times of the local photographing; determining, for each local photographing, a local point cloud of the to-be-detected workpiece; determining each first structure in the local point cloud and concavity-convexity of each first structure based on a structure search algorithm; determining an existing structure list of the to-be-detected workpiece;

an updating module 112, configured for merging each first structure into the existing structure list to obtain an updated structure list based on a structure merging algorithm, the number of times of the local photographing, and the concavity-convexity of each first structure, wherein the updated structure list includes a vote count of each structure;

a returning execution module 113, configured for returning to execute the step of determining, for each time of the local photographing, a local point cloud of the to-be-detected workpiece to the step of merging each first structure into the existing structure list to obtain an updated structure list based on a structure merging algorithm and the concavity-convexity of each first structure, until the number of times of the local photographing reaches a preset number, and obtaining a latest structure list;

an obtaining module 114, configured for obtaining a first target structure with a vote count greater than the preset number and parameter information of each first target structure from the latest structure list; and

a recognizing module 115, configured for performing linear weld seam recognition based on the parameter information.

The present disclosure further provides an electronic device 100, wherein the electronic device 100 includes a processor 130 and a memory 120. The memory 120 stores computer-executable instructions, which, when executed by the processor 130, implements the linear weld seam recognition method.

The present disclosure further provides a computer-readable storage medium, the storage medium storing a computer program, which, when executed by the processor 130, implements the linear weld seam recognition method.

In the embodiments provided in the present disclosure, it should be understood that the devices and methods disclosed can be implemented in other ways. The device embodiments described above are merely illustrative. For example, the flowcharts and diagrams in the drawings illustrate possible implementations, architectures, functions, and operations of devices, methods, and computer program products according to multiple embodiments of the present disclosure. At this point, each box in the flowchart or diagram can represent a module, program segment, or part of the code. Each part of the module, program segment, or code includes one or more executable instructions for implementing the specified logical functions. It should also be noted that in some alternative implementations, the functions indicated in the boxes may occur in a different order than that indicated in the drawings. For example, two consecutive boxes can actually be executed in parallel, and sometimes they can also be executed in reverse order, depending on the functionality involved. It should also be noted that each box in the block diagram and/or flowchart, and the combination of boxes in the block diagram and/or flowchart, can be implemented by specialized hardware systems designed to perform the specified functions or actions, or by a combination of specialized hardware and computer instructions.

Further, each functional module in each embodiment of the present disclosure can be integrated together to form a separate part, or each module may exist separately, or two or more modules may be integrated to form a separate part. The functionality, when implemented as a software functional module and sold or used as a stand-alone product, can be stored in computer-readable storage medium. Based on this understanding, the technical solution of the present disclosure can essentially be embodied in the form of a software product, which contributes to or includes parts in the prior art. The software product is stored in a storage medium and includes multiple instructions for causing a computer device (which can be a personal computer, server, network device, etc.) to execute all or some of the steps of the methods described in various embodiments of the present disclosure. The aforementioned storage media include various media that can store program code, such as USB drives, external hard drives, read-only memory (ROM), random access memory (RAM), disks, or optical discs.

It is important to note that, in the context, relationship terms such as first and second are used only to distinguish one entity or operation from another entity or operation, without necessarily requiring or implying any such actual relationship or order between those entities or operations. Furthermore, the terms “comprise”, “include”, or any other variations are intended to encompass non-exclusive inclusion. This allows a process, method, item, or device that includes a series of elements to not only include those elements but also include other elements that are not explicitly listed, or elements that are inherent to the process, method, item, or device. In the absence of further limitations, the inclusion of an element specified by the phrase "comprising a..." does not exclude the presence of additional identical elements in the process, method, article, or apparatus that includes the specified element.

The above are only various embodiments of the present disclosure, but the scope of protection of the present disclosure is not limited thereto. Any person skilled in the art can easily envisage changes or substitutions within the technical scope disclosed in the present disclosure, which should be encompassed within the scope of protection of the present disclosure. Therefore, the scope of protection of the present disclosure shall be stated to be subject to the scope of protection of the claims.

What is claimed is:

1. A linear weld seam recognition method, comprising steps of:
performing local photographing on a to-be-detected workpiece, and determining a number of times of the local photographing;
determining, for each time of the local photographing, a local point cloud of the to-be-detected workpiece;
determining each first structure in the local point cloud and concavity-convexity of each first structure based on a structure search algorithm;
determining an existing structure list of the to-be-detected workpiece;
merging each first structure into the existing structure list to obtain an updated structure list based on a structure merging algorithm, the number of times of the local photographing, and the concavity-convexity of each first structure, wherein the updated structure list comprises a vote count of each structure;
returning to execute the step of determining, for each time of the local photographing, the local point cloud of the to-be-detected workpiece to the step of merging each first structure into the existing structure list to obtain the updated structure list based on the structure merging algorithm and the concavity-convexity of each first structure, until the number of times of the local photographing reaches a preset number, and obtaining a latest structure list;
obtaining a first target structure with a vote count greater than the preset number and parameter information of each first target structure from the latest structure list; and
performing linear weld seam recognition based on the parameter information.

2. The method according to claim 1, wherein the step of determining each first structure in the local point cloud and the concavity-convexity of each first structure based on the structure search algorithm comprises steps of:
detecting each plane in the local point cloud;
constructing a pair list and a triple list based on each plane, wherein the pair list comprises at least one first structure formed by two planes and the concavity-convexity corresponding to this first structure, and the triple list comprises at least one first structure formed by three planes and the concavity-convexity corresponding to this first structure; and
determining a pair-only list based on the pair list and the triple list.

3. The method according to claim 2, wherein the step of constructing the pair list and the triple list based on each plane comprises steps of:
obtaining a plane detection list based on each plane;
determining whether a plane i and a plane j have an intersection line, wherein a variable i is used to traverse each plane in the plane detection list from 0 to n, and a variable j is used to traverses each plane in the plane detection list from i+1 to n, n being a number of planes in the plane detection list;
forming a pair by the plane i and the plane j, and recording this pair in the pair list, in response to that the plane i and the plane j have an intersection line;
determining whether the plane i and a plane k have an intersection line, wherein a variable k is used to traverse each plane in the plane detection list from j+1 to n;
forming a pair by the plane i and the plane k, and recording this pair in the pair list, in response to that the plane i and the plane k have an intersection line;
determining whether the plane j and the plane k have an intersection line;
forming a pair by the plane j and the plane k, and recording this pair in the pair list, in response to that the plane j and the plane k have an intersection line;
determining whether the plane i and the plane j have an intersection line, whether the plane i and the plane k have an intersection line, and whether the plane j and the plane k have an intersection line;
forming a triple list by the plane i, the plane j, and the plane k, and recording this triple list in the triple list, in response to that the plane i and the plane j have an intersection line, the plane i and the plane k have an intersection line, and the plane j and the plane k have an intersection line;
determining coordinates of a camera optical center during the local photographing; and
determining the concavity-convexity of each first structure in the pair list and the concavity-convexity of each first structure in the triple list based on the coordinates of the camera optical center.

4. The method according to claim 2, wherein the step of determining the pair-only list based on the pair list and the triple list comprises steps of:
determining whether a triple j comprises a pair i, wherein a variable i is used to traverse the pair list, and a variable j is used to traverse the triple list; and
in response to that the triple j does not comprise the pair i, determining the pair i as a pair-only, and adding the pair-only to a pair-only list.

5. The method according to claim 1, wherein the step of merging each first structure into the existing structure list to obtain the updated structure list based on the structure merging algorithm, the number of times of the local photographing, and the concavity-convexity of each first structure comprises:
in response to that the number of times of the local photographing is zero, adding each first structure to the existing structure list to obtain the updated structure list, and assigning the vote count of a newly added first structure in the updated structure list to 1.

6. The method according to claim 2, wherein the step of merging each first structure into the existing structure list to obtain the updated structure list based on the structure merging algorithm, the number of times of the local photographing, and the concavity-convexity of each first structure, and updating the vote count of each structure in the updated structure list comprises steps of:
in response to that the number of times of the local photographing is not zero, determining a new triple list according to the triple list and a target triple list in the existing structure list, wherein the existing structure list comprises the target triple list;
updating the existing structure list based on the triple list and the target triple list;
updating the existing structure list based on the new triple list and a target pair-only list in the existing structure list, wherein the existing structure list comprises the target pair-only list;
obtaining a temporary pair-only list based on the pair-only list and the target triple list;
updating the existing structure list based on the pair-only list and the target triple list; and
updating the existing structure list based on the temporary pair-only list and the target pair-only list.

7. The method according to claim 6, wherein the step of updating the existing structure list based on the triple list and the target triple list comprises:
determining whether a triple a and a target triple b have three common dihedral structures with identical concavity-convexity, wherein a variable a is used to traverse the triple list, and a variable b is used to traverse the target triple list;
in response to that the triple a and the target triple b have three common dihedral structures with identical concavity-convexity, merging the triple a into the existing structure list to obtain an updated structure list, and updating a vote count of the target triple b in the updated structure list;
in response to that the triple a and the target triple b do not have three common dihedral structures with identical concavity-convexity, determining whether the triple a and the target triple b have one common dihedral structure with identical concavity-convexity;
in the case that the triple a and the target triple b have one common dihedral structure with identical concavity-convexity, determining an associated structure list corresponding to the target triple b;
determining whether the associated structure list comprises a second target structure having three common dihedral structures with the triple a wherein these dihedral structures have identical concavity-convexity;
in response to that the associated structure list comprises the second target structure having three common dihedral structures with the triple a wherein these dihedral structures have identical concavity-convexity, determining a target label of the second target structure in the existing triple list, and
merging the triple a into the existing structure list to obtain the updated structure list;
in response to that the associated structure list does not comprise the second target structure having three common dihedral structures with the triple a wherein these dihedral structures have identical concavity-convexity, adding the triple a to the existing structure list to obtain the updated structure list; and
in response to that the triple a and the target triple b have no common dihedral structure, adding the triple a to the existing structure list to obtain the updated structure list.

8. The method according to claim 6, wherein the step of updating the existing structure list based on the new triple list and the target pair-only list in the existing structure list comprises:
determining whether a new triple i and a target pair-only j have a common dihedral structure with identical concavity-convexity, wherein a variable i is used to traverse each new triple in a new triple list, and a variable j is used to traverse each target pair-only list in a target pair-only list; and
in response to that the new triple i and the target pair-only j have a common dihedral structure with identical concavity-convexity, updating an intersection line of the new triple i based on an intersection line of the target pair-only j.

9. The method according to claim 6, wherein the step of obtaining the temporary pair-only list based on the pair-only list and the target triple list comprises:
determining whether a pair-only i and a target triple j have a common dihedral structure with identical concavity-convexity, wherein a variable i is used to traverse each pair-only in the pair-only list, and a variable j is used to traverse each target triple in the target triple list;
in response to that the pair-only i and the target triple j have a common dihedral structure with identical concavity-convexity, updating an intersection line of the target triple j based on an intersection line of the pair-only i; and
in response to that the pair-only i and the target triple j have no common dihedral structure, adding the pair-only i to the temporary pair-only list.

10. A linear weld seam recognition device, comprising: a determination module, configured for performing local photographing on a to-be-detected workpiece, and determining a number of times of the local photographing; determining, for each time of the local photographing, a local point cloud of the to-be-detected workpiece; determining each first structure in the local point cloud and concavity-convexity of each first structure based on a structure search algorithm; determining an existing structure list of the to-be-detected workpiece;
an updating module, configured for merging each first structure into the existing structure list to obtain an updated structure list based on a structure merging algorithm, the number of times of the local photographing, and the concavity-convexity of each first structure, wherein the updated structure list comprises a vote count of each structure;
a returning execution module, configured for returning to execute the step of determining, for each time of the local photographing, the local point cloud of the to-be-detected workpiece to the step of merging each first structure into the existing structure list to obtain the updated structure list based on the structure merging algorithm and the concavity-convexity of each first structure, until the number of times of the local photographing reaches a preset number, and obtaining a latest structure list;
an obtaining module, configured for obtaining a first target structure with a vote count greater than the preset number and parameter information of each first target structure from the latest structure list; and
a recognizing module, configured for performing linear weld seam recognition based on the parameter information.
